(19) United States
(12) Patent Application Publication
(10) Pub. No.: US 2011/0026169 A1
(43) Pub. Date: Feb. 3, 2011

(54) DUAL CPP GMR HEAD USING A SCISSOR SENSOR

(76) Inventors: Hardayal Singh Gill, Polo Alto, CA (US); Wen-Chien David Hsiao, San Jose, CA (US); Douglas Johnson Werner, Fremont, CA (US)

Correspondence Address: Zilka-Kotab, PC, P.O.Box 721120, San Jose, CA, 95172-1120, US

(21) Appl. No.: 12/510,560

(22) Filed: Jul. 28, 2009

(51) Int. Cl. G11B 5/127; B05D 5/12

(52) U.S. Cl. 360/324.12; 427/131; G9B/5.104

(57) ABSTRACT

A dual current-perpendicular-to-plane scissor sensor according to one embodiment includes a middle free layer; two outer free layers positioned on opposite sides of the middle free layer; spacer layers between the middle free layer and each of the outer free layers; and a hard bias layer positioned behind the free layers relative to a media-facing surface of the sensor, wherein the free layers are about magnetostatically balanced.

### FIELD OF THE INVENTION

The present invention relates to data storage systems, and more particularly, this invention relates to systems and methods of making for a giant magnetoresistive head using a scissor sensor.

### BACKGROUND OF THE INVENTION

The heart of a computer is a magnetic disk drive which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

There are many different types of read and/or write magnetic heads used in magnetic disk systems. One such type of read/write head is a giant magnetoresistive (GMR) head. Magnetic heads can be designed to operate as current-perpendicular-to-plane (CPP) or as current-in-plane (CIP).

Storage systems and methods generally demand a higher MR from the magnetic head in order to store more data and/or to store data more efficiently in closer-packed mediums. Therefore, a CPP magnetic head which can produce higher MR and still have stabilized free layers would be beneficial in advancing the abilities of storage systems and methods.

### SUMMARY OF THE INVENTION

A dual current-perpendicular-to-plane scissor sensor according to one embodiment includes a middle free layer; two outer free layers positioned on opposite sides of the middle free layer; spacer layers between the middle free layer and each of the outer free layers; and a hard bias layer positioned behind the free layers relative to a media-facing surface of the sensor, wherein the free layers are about magnetostatically balanced.

A system according to one embodiment includes at least one head for reading from and writing to a magnetic medium; at least one slider for supporting the at least one head, wherein each head is supported by one slider; and a control unit coupled to the at least one head for controlling operation of each head. Each head includes: a dual current-perpendicular-to-plane scissor sensor; and a writer coupled to the sensor. The sensor further comprises: a middle free layer; two outer free layers positioned on opposite sides of the middle free layer; spacer layers between the middle free layer and each of the outer free layers; and a hard bias layer positioned behind the free layers relative to a media-facing surface of the sensor, wherein the free layers are about magnetostatically balanced.

A method of making a dual current-perpendicular-to-plane scissor sensor according to one embodiment includes forming a first outer free layer above a magnetic shield; forming a first spacer layer above the first outer free layer; forming a middle free layer above the first spacer layer; forming a second spacer layer above the middle free layer; forming a second outer free layer above the middle free layer; and forming a hard bias layer behind the free layers, wherein the free layers are about magnetostatically balanced.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system.

FIG. 2A is a schematic representation in section of a recording medium utilizing a longitudinal recording format.

FIG. 2B is a schematic representation of a conventional magnetic recording head and recording medium combination for longitudinal recording as in FIG. 2A.

FIG. 2C is a magnetic recording medium utilizing a perpendicular recording format.

FIG. 2D is a schematic representation of a recording head and recording medium combination for perpendicular recording on one side.

FIG. 2E is a schematic representation of a recording apparatus adapted for recording separately on both sides of the medium.

FIG. 3A is a cross-sectional view of one particular embodiment of a perpendicular magnetic head with helical coils.

FIG. 3B is a cross-sectional view of one particular embodiment of a piggyback magnetic head with helical coils.

FIG. 4A is a cross-sectional view of one particular embodiment of a perpendicular magnetic head with looped coils.

FIG. 4B is a cross-sectional view of one particular embodiment of a piggyback magnetic head with looped coils.

FIG. 5 is a flowchart of a method for forming at least a portion of a magnetic head according to one embodiment.

FIG. 6 is a cross sectional view of a portion of a dual CPP scissor sensor of a magnetic head according to one embodiment.

FIG. 7 is a plot showing a comparative representation of the total magnetic layer thickness dependence of RA and ΔRA for a single spin valve (SV) sensor and a dual spin valve sensor.

FIG. 8A shows the magnetic orientations of the free layers and the hard bias layer according to one embodiment.

FIG. 8B shows the magnetic orientations of the free layers, a magnetic medium with an additive magnetic orientation, and the hard bias layer according to one embodiment.

FIG. 8C shows the magnetic orientations of the free layers, a magnetic medium with an opposing magnetic orientation, and the hard bias layer according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of disk-based storage systems and/or related systems and methods, as well as operation and/or component parts thereof.

In one general embodiment, a dual current-perpendicular-to-plane (CPP) scissor sensor comprises a middle free layer; two outer free layers positioned on opposite sides of the middle free layer; spacer layers between the middle free layer and each of the outer free layers; and a hard bias layer positioned behind the free layers relative to a media-facing surface of the sensor, wherein the free layers are about magnetostatically balanced.

In another general embodiment, a system comprises at least one head for reading from and writing to a magnetic medium; a slider for supporting the head; and a control unit coupled to the head for controlling operation of the head, wherein each head includes: a dual current-perpendicular-to-plane scissor sensor; and a writer coupled to the sensor, wherein the sensor further comprises: a middle free layer; two outer free layers positioned on opposite sides of the middle free layer; spacer layers between the middle free layer and each of the outer free layers; and a hard bias layer positioned behind the free layers relative to a media-facing surface of the sensor, wherein the free layers are about magnetostatically balanced.

In yet another general embodiment, a method of making a dual current-perpendicular-to-plane scissor sensor comprises forming first outer free layer above a magnetic shield; forming a first spacer layer above the first outer free layer; forming a middle free layer above the first spacer layer; forming a second spacer layer above the middle free layer; forming a second outer free layer above the middle free layer; and forming a hard bias layer behind the free layers, wherein the free layers are about magnetostatically balanced.

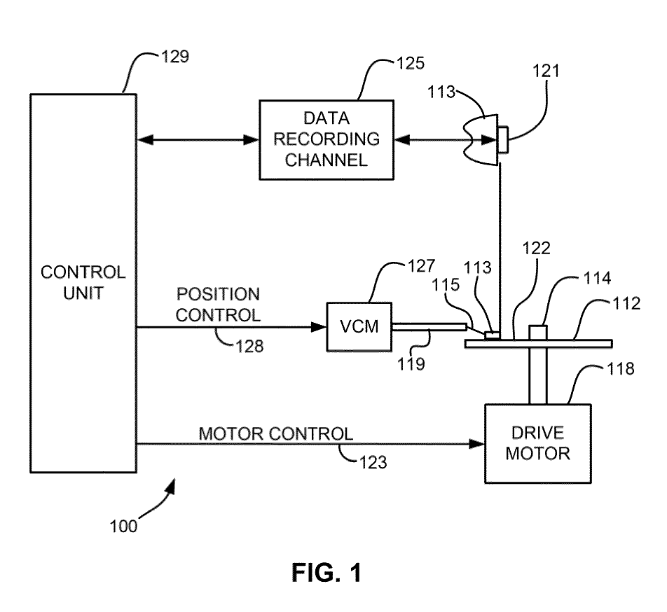

Referring now to FIG. 1, there is shown a disk drive 100 in accordance with one embodiment of the present invention. As shown in FIG. 1, at least one rotatable magnetic disk 112 is supported on a spindle 114 and rotated by a disk drive motor 118. The magnetic recording on each disk is typically in the form of an annular pattern of concentric data tracks (not shown) on the disk 112.

At least one slider 113 is positioned near the disk 112, each slider 113 supporting one or more magnetic read/write beads 121. As the disk rotates, slider 113 is moved radially in and out over disk surface 122 so that heads 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by control unit 129, such as access control signals and internal clock signals. Typically, control unit 129 comprises logic control circuits, storage (e.g., memory), and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write heads 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write head includes a coil layer embedded in one or more insulation layers (insulation stack), the insulation stack being located between first and second pole piece layers. A gap is formed between the first and second pole piece layers by a gap layer at an air bearing surface (ABS) of the write head. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

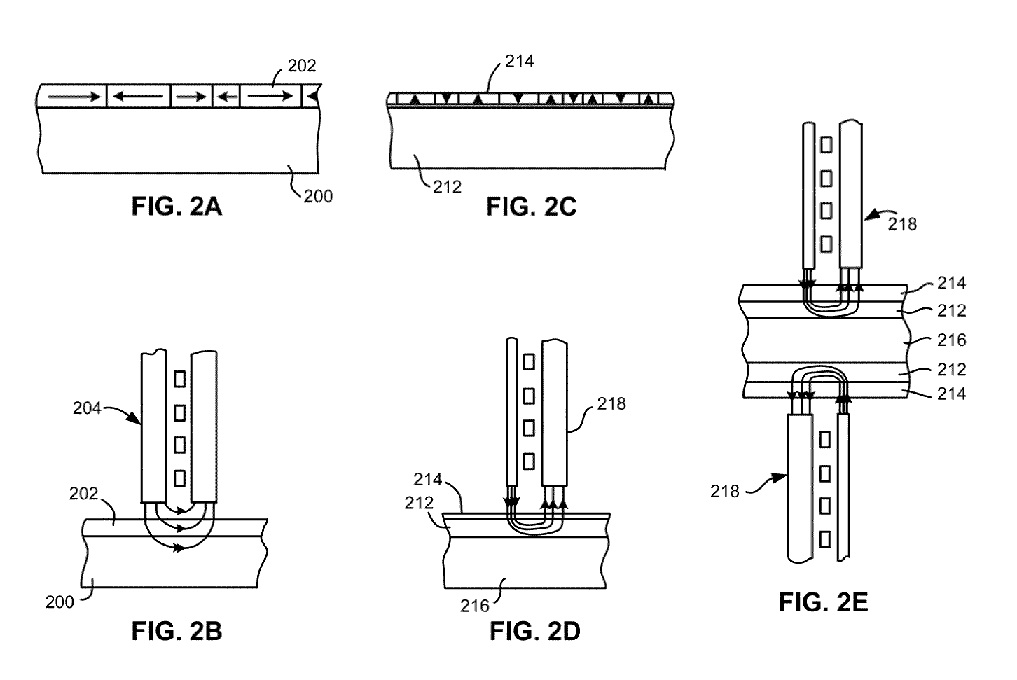

FIG. 2A illustrates, schematically, a conventional recording medium such as used with magnetic disc recording systems, such as that shown in FIG. 1. This medium is utilized for recording magnetic impulses in or parallel to the plane of the medium itself. The recording medium, a recording disc in this instance, comprises basically a supporting substrate 200 of a suitable non-magnetic material such as glass, with an overlying coating 202 of a suitable and conventional magnetic layer.

FIG. 2B shows the operative relationship between a conventional recording/playback head 204, which may preferably be a thin film head, and a conventional recording medium, such as that of FIG. 2A.

FIG. 2C illustrates, schematically, the orientation of magnetic impulses substantially perpendicular to the surface of a recording medium as used with magnetic disc recording systems, such as that shown in FIG. 1. For such perpendicular recording the medium typically includes an under layer 212 of a material having a high magnetic permeability. This under layer 212 is then provided with an overlying coating 214 of magnetic material preferably having a high coercivity relative to the under layer 212.

FIG. 2D illustrates the operative relationship between a perpendicular head 218 and a recording medium. The recording medium illustrated in FIG. 2D includes both the high permeability under layer 212 and the overlying coating 214 of magnetic material described with respect to FIG. 2C above. However, both of these layers 212 and 214 are shown applied to a suitable substrate 216. Typically there is also an additional layer (not shown) called an “exchange-break” layer or “interlayer” between layers 212 and 214.

In this structure, the magnetic lines of flux extending between the poles of the perpendicular head 218 loop into and out of the overlying coating 214 of the recording medium with the high permeability under layer 212 of the recording medium causing the lines of flux to pass through the overlying coating 214 in a direction generally perpendicular to the surface of the medium to record information in the overlying coating 214 of magnetic material preferably having a high coercivity relative to the under layer 212 in the form of magnetic impulses having their axes of magnetization substantially perpendicular to the surface of the medium. The flux is channeled by the soft underlying coating 212 back to the return layer (P1) of the head 218.

FIG. 2E illustrates a similar structure in which the substrate 216 carries the layers 212 and 214 on each of its two opposed sides, with suitable recording heads 218 positioned adjacent the outer surface of the magnetic coating 214 on each side of the medium, allowing for recording on each side of the medium.

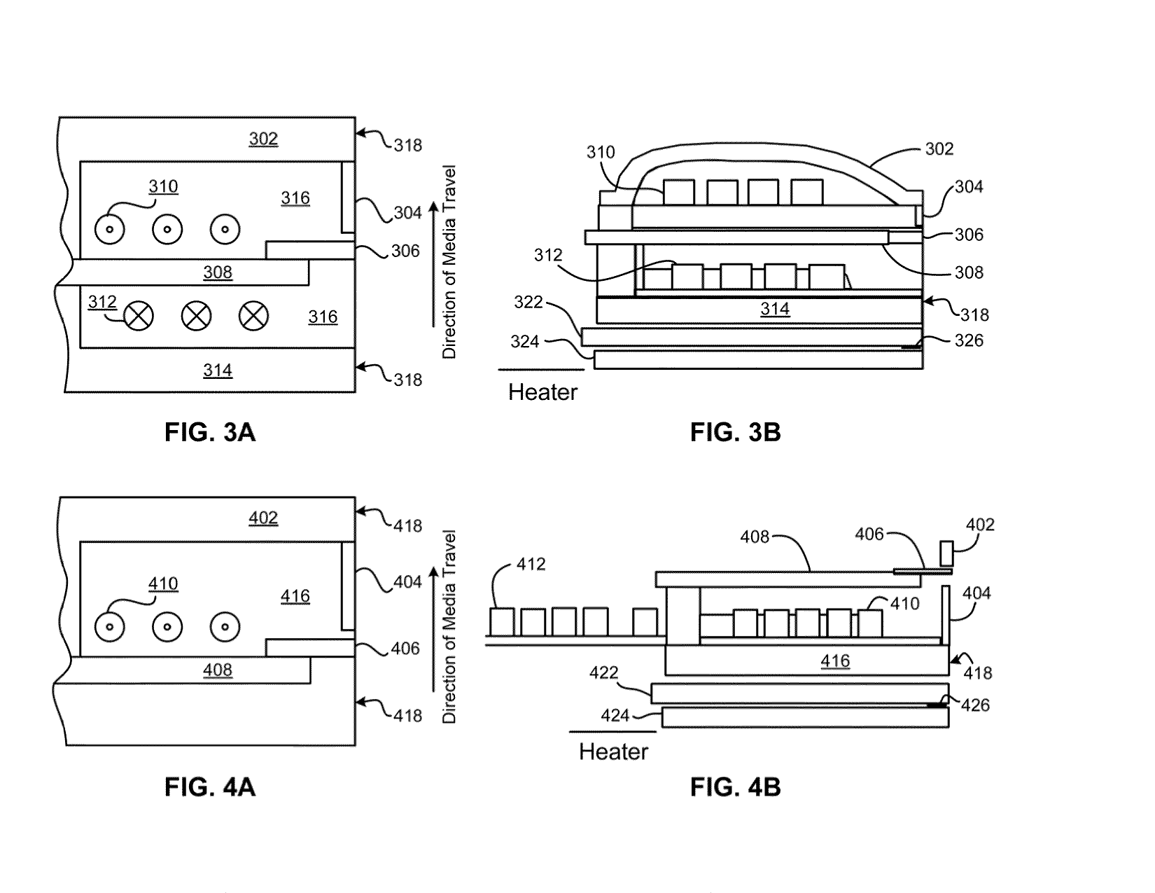

FIG. 3A is a cross-sectional view of a perpendicular magnetic head. In FIG. 3A, helical coils 310 and 312 are used to create magnetic flux in the stitch pole 308, which then delivers that flux to the main pole 306. Coils 310 indicate coils extending out from the page, while coils 312 indicate coils extending into the page. Stitch pole 308 may be recessed from the ABS 318. Insulation 316 surrounds the coils and may provide support for some of the elements. The direction of the media travel, as indicated by the arrow to the right of the structure, moves the media past the lower return pole 314 first, then past the stitch pole 308, main pole 306, trailing shield 304 which may be connected to the wrap around shield (not shown), and finally past the upper return pole 302. Each of these components may have a portion in contact with the ABS 318. The ABS 318 is indicated across the right side of the structure.

Perpendicular writing is achieved by forcing flux through the stitch pole 308 into the main pole 306 and then to the surface of the disk positioned towards the ABS 318.

FIG. 3B illustrates a piggyback magnetic head having similar features to the head of FIG. 3A. Two shields 304, 314 flank the stitch pole 308 and main pole 306. Also sensor shields 322, 324 are shown. The sensor 326 is typically positioned between the sensor shields 322, 324.

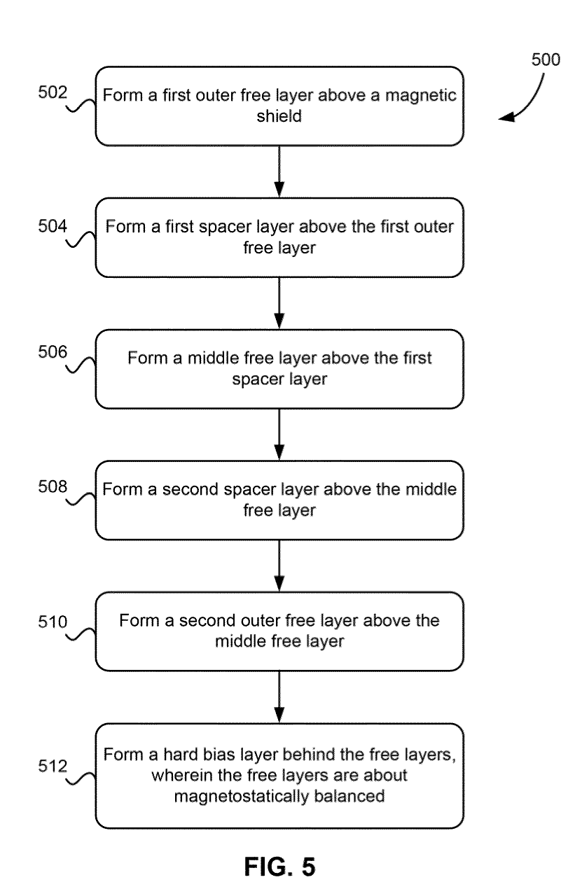

FIG. 4A is a schematic diagram of one embodiment which uses looped coils 410, sometimes referred to as a pancake configuration, to provide flux to the stitch pole 408. The stitch pole then provides this flux to the main pole 406. In this orientation, the lower return pole is optional. Insulation 416 surrounds the coils 410, and may provide support for the stitch pole 408 and main pole 406. The stitch pole may be recessed from the ABS 418. The direction of the media travel, as indicated by the arrow to the right of the structure, moves the media past the stitch pole 408, main pole 406, trailing shield 404 which may be connected to the wrap around shield (not shown), and finally past the upper return pole 402 (all of which may or may not have a portion in contact with the ABS 418). The ABS 418 is indicated across the right side of the structure. The trailing shield 404 may be in contact with the main pole 406 in some embodiments.

FIG. 4B illustrates another type of piggyback magnetic head having similar features to the head of FIG. 4A including a helical coil 410, which wraps around to form helical coil 412. Also, sensor shields 422, 424 are shown. The sensor 426 is typically positioned between the sensor shields 422, 424.

In FIGS. 3B and 4B, an optional heater is shown near the non-ABS side of the magnetic head. A heater (Heater) may also be included in the magnetic heads shown in FIGS. 3A and 4A. The position of this heater may vary based on design parameters such as where the protrusion is desired, coefficients of thermal expansion of the surrounding layers, etc.

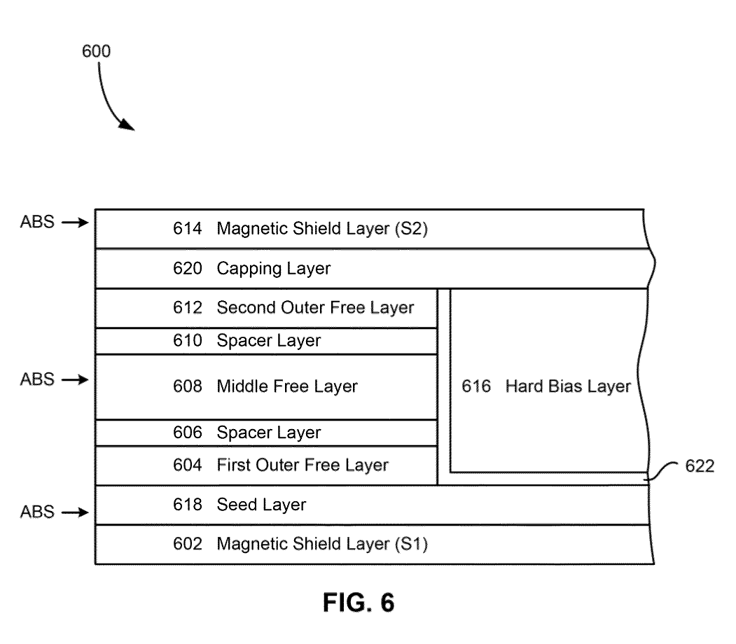

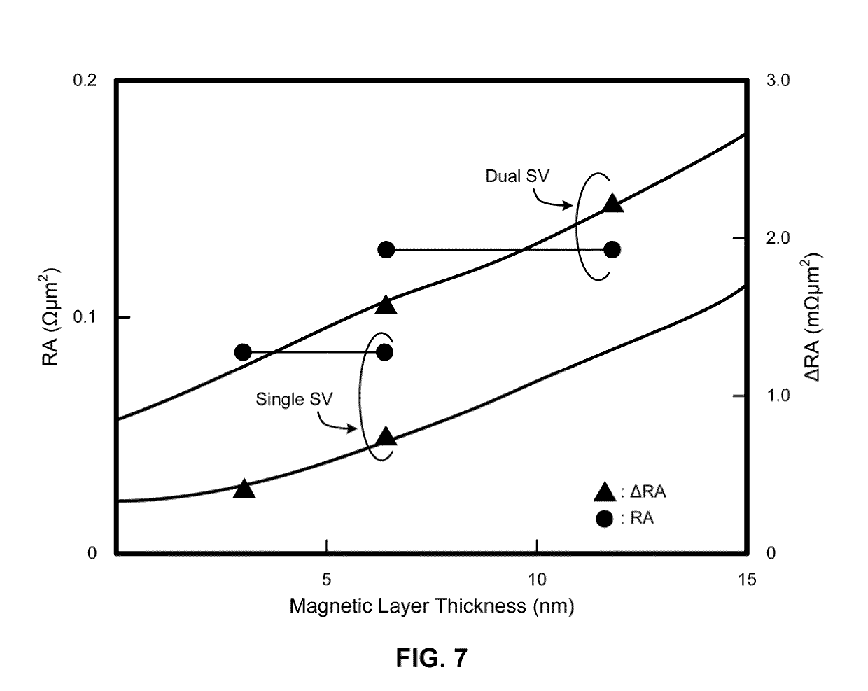

Now referring to FIG. 5, a method 500 of making a dual CPP scissor sensor, such as the sensor 600 shown in FIG. 6, is described according to one embodiment. The method 500 of FIG. 5 may be carried out in any desired environment, and may include intermediate, prior and/or later operations not described below. Of course, the dual CPP scissor sensor produced through the method 500 may be used with and/or in other systems to produce a tangible portion of a magnetic head for reading and/or writing to a magnetic medium.

In operation 502, a first outer free layer is formed above a magnetic shield. It is not required that the outer free layer be adjacent to the magnetic shield, but in some embodiments, the outer free layer may be adjacent to the magnetic shield.

In operation 504, a first spacer layer is formed above the first outer free layer. Once again, it is not a requirement of the method 500 that the first spacer layer be adjacent to the first outer free layer, as other layers may be included between the two layers. However, in some embodiments, the first spacer layer may be adjacent the first outer free layer.

In operation 506, a middle free layer is formed above the first spacer layer. Once again, it is not a requirement of the method 500 that the first spacer layer be adjacent to the middle free layer, as other layers may be included between the two layers. However, in some embodiments, the first spacer layer may be adjacent the middle free layer.

In operation 508, a second spacer layer is formed above the middle free layer. It is not a requirement of the method 500 that the second spacer layer be adjacent to the middle free layer, as other layers may be included between the two layers. However, in some embodiments, the second spacer layer may be adjacent the middle free layer.

In operation 510, a second outer free layer is formed above the middle free layer. It is not a requirement of the method 500 that the second outer free layer be adjacent to the middle free layer, as other layers may be included between the two layers. However, in some embodiments, the second outer free layer may be adjacent the middle free layer.

In operation 512, a hard bias layer is formed behind the free layers relative to a future media-facing surface of the sensor. For example, an air-bearing surface (ABS) of the sensor may be formed at some point after definition of the hard bias layer. In addition, the free layers are preferably about magnetostatically balanced. In other words, a net magnetic moment of the first and second outer free layers' about balances the magnetic moment of the middle free layer.

According to some approaches, a ratio of net magnetic thicknesses of the first and second outer free layers to the middle free layer may be between about 50:50 and about 60:40. In a more precise approach, the ratio is about 60:40.

The first and second outer free layers have an at rest magnetic orientation which may be influenced by factors, such as the at rest magnetic orientation of the middle free layer. In some approaches, the at rest magnetic orientations of the first and second outer free layers may each be oriented at an angle of between about 70° and about 90° relative to an at rest magnetic orientation of the middle free layer.

In other approaches, the at rest magnetic orientations of the first and second outer free layers may each be oriented at an angle of about 90° from an at rest magnetic orientation of the middle free layer. In a further approach, the at rest magnetic orientations of the first and second outer free layers may each be oriented at an angle of about 45° relative to a future media-facing surface of the sensor. As previously mentioned, an ABS or some other media-facing surface of the sensor may be formed at some point after definition of the hard bias layer.

In some embodiments, the at rest magnetic orientations of the first and second outer free layers may be oriented about parallel to each other. For example, if the at rest magnetic orientation of the first outer free layer is oriented at an angle of about 60° from an at rest magnetic orientation of the middle free layer, the at rest magnetic orientation of the second outer free layer may be oriented at an angle of about 60° from an at rest magnetic orientation of the middle free layer.

In some preferred embodiments, the method 500 may not include any operations to form pinned layers. In addition, the resulting sensor produced from the method 500 may have no pinned layers present in the sensor.

Now with reference to FIG. 6, a dual CPP scissor sensor 600 may be described according to one embodiment. The sensor 600 includes a middle free layer 608 and two outer free layers 604, 612 positioned on opposite sides of the middle free layer 608. The first outer free layer 604 is positioned below the middle free layer 608 while the second outer free layer 612 is positioned above the middle free layer 608. The sensor 600 also includes spacer layers 606, 610 between the middle free layer 608 and each of the outer free layers 604, 612. In addition, the sensor 600 includes a hard bias layer 616 positioned behind the free layers relative to a media-facing surface of the sensor, i.e., on an opposite side of the free layers as the media-facing surface, such as an ABS. Also, the free layers 604, 608, 612 are about magnetostatically balanced. In other words, a net magnetic moment of the outer free layers 604, 612 less any field shunted therefrom by surrounding layers, such as the nearest shield about balances the magnetic moment of the middle free layer 608.

According to some embodiments, the sensor 600 includes no pinned layers.

In some embodiments, the sensor 600 may also include a capping layer 620 above the second outer free layer 612, and a magnetic shield layer (S2) 614 above the second outer free layer 612, and an electrically insulating layer 622 between the hard bias layer 616 and the free layers 604, 608, 612, and the seed layer 618. According to some embodiments, the electrically insulating layer 622 may be comprised of Al₂O₃, AlO, TiO₂, TiC, SO₃N₄, etc.

In even more embodiments, the sensor 600 may further include a seed layer 618 above a magnetic shield layer (S1) 602, for helping in the formation of the layers above the seed layer 618.

The materials used to form the sensor 600 may be of the kind known to those of ordinary skill in the relevant art. For example, the free layers 604, 608, 612 may be comprised of ferromagnetic materials, such as Co, Fe, Ni, CoFe, NiFe, half metals, etc., and combinations thereof. In another example, the spacer layers 606, 610 may be comprised of electrically conductive materials such as Cu, Au, Ag, etc., and combinations thereof.

In some approaches, a ratio of net magnetic thicknesses of the outer free layers 604, 612 to the middle free layer 608 may be between about 50:50 and about 60:40, where “about” means±5 for each value, e.g., about 50:50 includes 55:45, 45:55, and all values in between.

In more approaches, a ratio of net magnetic thicknesses of the outer free layers 604, 612 to the middle free layer 608 may be about 60:40, where “about” means±5 for each value.

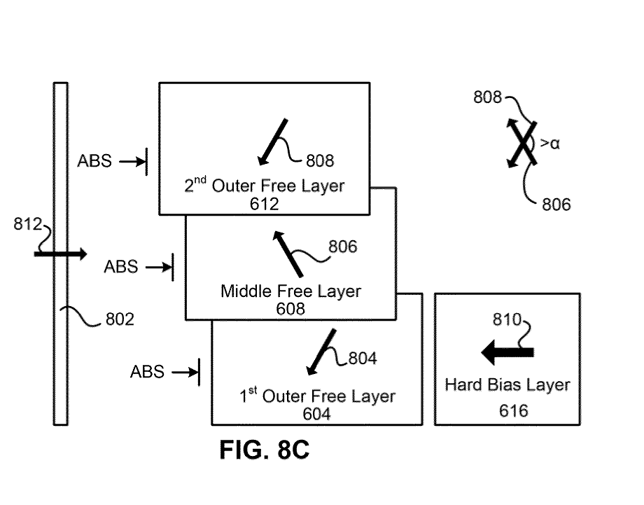

According to some embodiments, the at rest magnetic orientations (i.e., the magnetic orientation absent influence of an external magnetic field, e.g., from a disk) of the outer free layers 604, 612 may each be oriented at an angle of between about 70° and about 90° from an at rest magnetic orientation of the middle free layer 608, where “about” means±2.5°. This orientation is explained in more detail during the description of FIGS. 8A-8C, infra.

In some more embodiments, the at rest magnetic orientations of the outer free layers 604, 612 may each be oriented at an angle of about 90° from an at rest magnetic orientation of the middle free layer 608. In further embodiments, the at rest magnetic orientations of the outer free layers 604, 612 may each be oriented at an angle of about 45° from the media-facing surface of the sensor, such as an ABS. These orientations are explained in more detail during the description of FIGS. 8A-8C, infra.

In some approaches, the at rest magnetic orientations of the outer free layers 604, 612 may be oriented about parallel to each other. This orientation is explained in more detail during the description of FIGS. 8A-8C, infra.

According to some embodiments, the B-field in all of the free layers 604, 608, 612 may be matched by providing a thicker middle free layer 608. If the thicknesses of the free layers 604, 608, 612 are equal, it is unlikely that the B-field may be matched. Therefore, by providing more demagnetizing field shunting to the shields related to the outer free layers 604, 612, the free layers 604, 608, 612 may have thicknesses of 30 Å, 40 Å, 30 Å, respectively, according to one embodiment. Of course, other thicknesses are also possible, and may be determined, e.g., based on matching the B-field in all of the free layers 604, 608, 612.

Of course, the sensor 600 may be included in a system and/or magnetic head for writing to and/or reading from a magnetic medium of some kind, such as a hard disk.

In one such embodiment, with reference to FIG. 1, a system 100 comprises a magnetic medium 122, and at least one head 121 for reading from and/or writing to the magnetic medium 122. The system 100 also includes at least one slider 113 for supporting the at least one head 121 and a control unit 129 coupled to the at least one head 121 for controlling operation of the at least one head 121. In addition, each head 121 includes the sensor (600, FIG. 6) and a writer coupled to the sensor (600, FIG. 6).

Any of the embodiments and approaches described for the sensor 600 may also be used in the system 100.

Now referring to FIGS. 8A-8C, the magnetic orientations of the free layers (first outer free layer 604, middle free layer 608, second outer free layer 612), hard bias layer 616, and influencing object 802 are described according to several embodiments.

FIG. 8A shows the three free layers 604, 608, 612 in an offset stacked configuration. Of course, in operation, the layers would be above and below each other, and not offset as shown in FIG. 8A for clarity. In addition, although the ABS is shown for each layer, it would actually be a continuous flat plane of reference which would be shared by each layer 604, 608, 612.

In FIG. 8A, the magnetic orientations 804, 806, 808 of the free layers 604, 608, 612 are influenced by the magnetic orientation 810 of the hard bias layer 616. The magnetic orientation 810 of the hard bias layer 616 generally will be in a direction toward the media-facing surface of the sensor, such as the ABS. However, in some embodiments, the magnetic orientation 810 of the hard bias layer 616 may be in a direction away from the media-facing surface of the sensor, such as the ABS.

The at rest magnetic orientation indicates the free layers' magnetic orientations 804, 806, 808 when only influenced by the hard bias layer's magnetic orientation 810. When the hard bias layer's magnetic orientation 810 is not present, the free layers' magnetic orientations 804, 806, 808 would be about antiparallel to one another, perpendicular to the media-facing surface of the sensor, such as the ABS. In this magnetic orientation, the sensor stack is at its most electrically resistant state. When the magnetic orientations of the free layers 804, 806, 808 become about parallel with each other, this is when the sensor stack is at its least electrically resistant state.

In some preferred embodiments, the magnetic orientations 804, 808 of the outer free layers 604, 612, respectively, are oriented at an at rest angle α of about 90° from the at rest magnetic orientation 806 of the middle free layer 608. In further embodiments, the at rest magnetic orientations 804, 808 of the outer free-layers 604, 612 may each be oriented at an angle β of about 45° from the media-facing surface of the sensor, such as an ABS.

Now referring to FIG. 8B, a magnetic medium 802 is shown with a magnetic orientation 812 that is additive to the hard bias layer's magnetic orientation 810. This effect causes the free layers' magnetic orientations 804, 806, 808 to become more parallel than they were at rest. As shown in the small detail in the upper right corner of FIG. 8B, the angle between the outer free layers' magnetic orientations 804, 808 and the middle free layer's magnetic orientation 806 may be less than α.

Now referring to FIG. 8C, a magnetic medium 802 is shown with a magnetic orientation 812 that is opposing to the hard bias layer's magnetic orientation 810. This effect causes the free layers' magnetic orientations 804, 806, 808 to become more antiparallel than they were at rest. As shown in the small detail in the upper right corner of FIG. 8C, the angle between the outer free layers' magnetic orientations 804, 808 and the middle free layer's magnetic orientation 806 may be greater than a.

There are several advantages to forming a sensor using the methods disclosed herein, and using a sensor formed according to the methods disclosed herein. One of these advantages includes providing about 50% greater magnetoresistance (GMR) across the sensor compared to prior art GMR scissor sensors. This increase in GMR may be a result of the doubling of interfaces between magnetic layers and spacer layers, from two interfaces for prior art sensors to four interfaces in embodiments of the present invention.

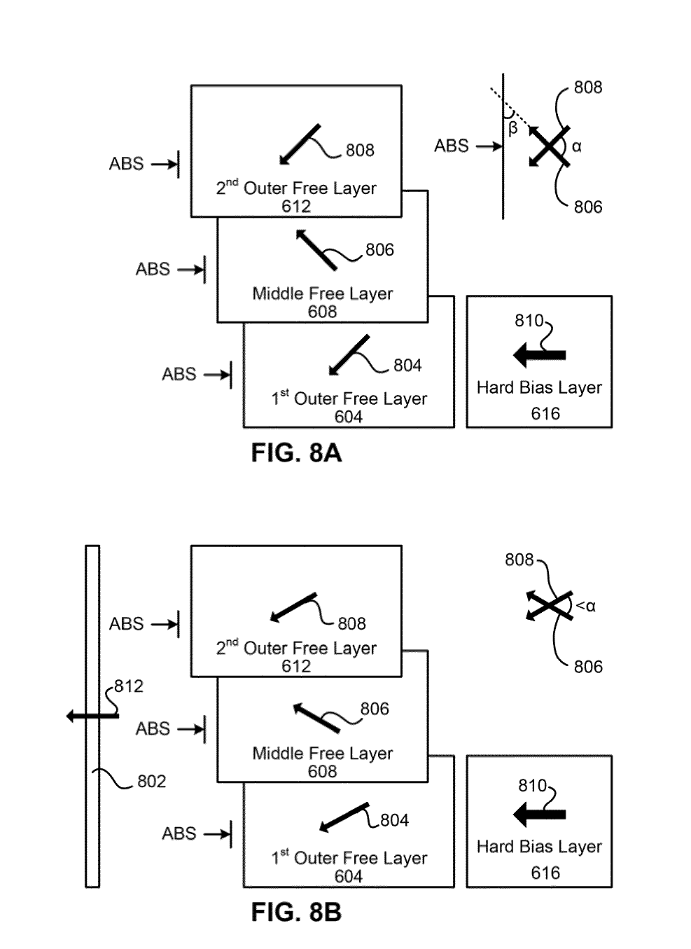

Now referring to FIG. 7, a comparative representation of the total magnetic layer thickness dependence of RA and ΔRA is shown for a single spin valve (SV) sensor and a dual spin valve sensor. The chart, taken from FUJITSU Sci. Tech. J., 37, 2 (December 2001), may be used as a guide when forming an embodiment of a sensor as disclosed herein, according to one approach. As can be seen in FIG. 7, as the thickness of the magnetic layer is increased, the RA increases. However, the RA for dual SV sensors is greater than the RA for single SV sensors. The RA increase is due to the series connection of the two spin valve sensors. The ΔRA increase for the dual spin valve sensor over the single spin sensor arises from enhanced interface scattering at the interfaces of free layers and Cu spacers. Since the number of interfaces are increased by 2× from single to dual configuration, this provides a substantial increase in ΔRA. Usually this type of increase is made possible by increasing the number of interfaces as long as the total film thickness is less than the spin diffusion length of the material. The CoFe spin diffusion length may urge towards keeping the total magnetic layer thicknesses (total of all free layers) below about 100 Å. However, for some other materials, e.g., Heusler alloys, spin diffusion length is lower (<50 Å) and the optimum ΔRA may be reached at smaller total free layer thicknesses.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A dual current-perpendicular-to-plane scissor sensor, comprising:
a middle free layer;
two outer free layers positioned on opposite sides of the middle free layer;
spacer layers between the middle free layer and each of the outer free layers; and
a hard bias layer positioned behind the free layers relative to a media-facing surface of the sensor,
wherein the free layers are about magnetostatically balanced.

2. The sensor of claim 1, wherein a ratio of net magnetic thicknesses of the outer free layers to the middle free layer is between about 50:50 and about 60:40.

3. The sensor of claim 1, wherein a ratio of net magnetic thicknesses of the outer free layers to the middle free layer is about 60:40.

4. The sensor of claim 1; wherein at rest magnetic orientations, of the outer free layers are each oriented at an angle of between about 70° and about 90° from an at rest magnetic orientation of the middle free layer.

5. The sensor of claim 1, wherein at rest magnetic orientations of the outer free layers are each oriented at an angle of about 90° from an at rest magnetic orientation of the middle free layer.

6. The sensor of claim 5, wherein the at rest magnetic orientations of the outer free layers are each oriented at an angle of about 45° from the media-facing surface of the sensor.

7. The sensor of claim 1, wherein at rest magnetic orientations of the outer free layers are oriented about parallel to each other.

8. The sensor of claim 1, with the proviso that no pinned layers are present in the sensor.

9. A system having a sensor as recited in claim 1, the system comprising:
a magnetic medium;
at least one head for reading from and writing to the magnetic medium, each head having:
the sensor; and
a writer coupled to the sensor;
at least one slider for supporting the at least one head, wherein each head is supported by one slider; and
a control unit coupled to the at least one head for controlling operation of each head.

10. A system, comprising:
at least one head for reading from and writing to a magnetic medium;
at least one slider for supporting the at least one head, wherein each head is supported by one slider; and
a control unit coupled to the at least one head for controlling operation of each head,
wherein each head includes:
a dual current-perpendicular-to-plane scissor sensor; and
a writer coupled to the sensor,
wherein the sensor further comprises:
a middle free layer;
two outer free layers positioned on opposite sides of the middle free layer;
spacer layers between the middle free layer and each of the outer free layers; and
a hard bias layer positioned behind the free layers relative to a media-facing surface of the sensor,
wherein the free layers are about magnetostatically balanced.

11. The system of claim 10, wherein a ratio of net magnetic thicknesses of the outer free layers to the middle free layer is between about 50:50 and about 60:40.

12. The system of claim 10, wherein a ratio of net magnetic thicknesses of the outer free layers to the middle free layer is about 60:40.

13. The system of claim 10, wherein at rest magnetic orientations of the outer free layers are each oriented at an angle of between about 70° and about 90° from an at rest magnetic orientation of the middle free layer.

14. The system of claim 10, wherein at rest magnetic orientations of the outer free layers are each oriented at an angle of about 90° from an at rest magnetic orientation of the middle free layer.

15. The system of claim 14, wherein the at rest magnetic orientations of the outer free layers are each oriented at an angle of about 45° from the media-facing surface of the sensor.

16. The system of claim 10, wherein at rest magnetic orientations of the outer free layers are oriented about parallel to each other.

17. The system of claim 10, with the proviso that no pinned layers are present in the sensor.

18. A method of making a dual current-perpendicular-to-plane scissor sensor, comprising:
forming a first outer free layer above a magnetic shield;
forming a first spacer layer above the first outer free layer;
forming a middle free layer above the first spacer layer;
forming a second spacer layer above the middle free layer;
forming a second outer free layer above the middle free layer; and
forming a hard bias layer behind the free layers,
wherein the free layers are about magnetostatically balanced.

19. The method of claim 18, wherein a ratio of net magnetic thicknesses of the outer free layers to the middle free layer is between about 50:50 and about 60:40.

20. The method of claim 18, wherein a ratio of net magnetic thicknesses of the outer free layers to the middle free layer is about 60:40.

21. The method of claim 18, wherein at rest magnetic orientations of the outer free layers are each oriented at an angle of between about 70° and about 90° from an at rest magnetic orientation of the middle free layer.

22. The method of claim 18, wherein at rest magnetic orientations of the outer free layers are each oriented at an angle of about 90° from an at rest magnetic orientation of the middle free layer.

23. The method of claim 22, wherein the at rest magnetic orientations of the outer free layers are each oriented at an angle of about 45° from the media-facing surface of the sensor.

24. The method of claim 18, wherein at rest magnetic orientations of the outer free layers are oriented about parallel to each other.

25. The method of claim 18, with the proviso that no pinned layers are present in the sensor.
